(19) United States
(12) Patent Application Publication
(10) Pub. No.: US 2019/0053436 A1
(43) Pub. Date: Feb. 21, 2019

(54) KNOTTER WITH CLIP RETAINED BILLHOOK FOR BALER

(71) Applicant: AGCO Corporation, Duluth, GA (US)

(72) Inventors: Robert L. FIGGER, Hesston, KS (US); David A. Becker, Newton, KS (US); Patrick Kendrick, Hesston, KS (US)

(21) Appl. No.: 15/681,116

(22) Filed: Aug. 18, 2017

(51) Int. Cl. A01F 15/14

(52) U.S. Cl. CPC A01F 15/145; A01F 15/00

(57) ABSTRACT

A knotter assembly for a baler, the knotter assembly configured to form knots in strands of a binding material used to secure a formed bale. The knotter assembly includes a generally circular knotter disc, a rotary billhook, and a pinion which is disposed for meshing engagement with a pair of circumferentially spaced gear stretches on the knotter disc such that rotational movement of the billhook is driven by the knotter disc through engagement of the gear stretches with the pinion. The billhook includes a billhook shaft, wherein the billhook shaft is received in an opening of the pinion. A retaining clip engages the billhook shaft to couple the billhook with the pinion. The retaining clip is C-shaped with a mouth configured to receive the billhook shaft and teeth that engage a groove around at least a portion of the circumference of the billhook shaft.

### BACKGROUND OF THE INVENTION

### Field of Invention

This invention relates to equipment for binding bales of crop material and the like while such bales are being produced in a baler.

### Description of Related Art

Mechanisms for binding bales of crop materials or other substances with strands of twine or wire are well known in the art. Typically, balers are equipped with means to wrap a binding material such as twine around the formed bale and tie off the twine with a knot to secure the bale. This includes a knotter assembly having a knotter disc rotated by a powered drive shaft that controls a rotational movement of the components of the knotter assembly. A twine disc holds the twine in position for engagement by a billhook and a swing arm form the knot.

With the desire to form bales with more densely packed crop material, it is necessary to use heavier twine and form stronger knots. The increased forces in the high density bales put higher stresses on the components of the knotter assembly. The billhooks on large square baler knotter currently use a pin to drive the billhook. Often, the pin is not strong enough to tie heavier twine used with high density bales and a larger pin is not feasible due to size of the billhook shaft. If the billhook on the knotter assembly shears its drive pin, the displaced billhook has a tendency to fall down into the wiper arm or other baler components, which could cause considerable damage. Repairing such damage is expensive and time consuming for the operator during the critical period when the cut crop is exposed to the elements.

### OVERVIEW OF THE INVENTION

In one embodiment, the invention is directed to a knotter assembly for use with a baler, the knotter assembly configured to form knots in strands of a binding material used to secure a formed bale. The knotter assembly includes a generally circular knotter disc, a rotary billhook, and a pinion which is disposed for meshing engagement with a pair of circumferentially spaced gear stretches on the knotter disc such that rotational movement of the billhook is driven by the knotter disc through engagement of the gear stretches with the pinion. The billhook includes a billhook shaft, wherein the billhook shaft is received in an opening of the pinion. A retaining clip engages the billhook shaft to couple the billhook with the pinion and to set the location of the pinion with respect to the billhook. The retaining clip is C-shaped with a mouth configured to receive the billhook shaft and teeth that engage a groove around at least a portion of the circumference of the billhook shaft.

These and other features and advantages of this invention are described in, or are apparent from, the following detailed description of various exemplary embodiments of the systems and methods according to this invention.

### BRIEF DESCRIPTION OF THE DRAWINGS

The above mentioned and other features of this invention will become more apparent and the invention itself will be better understood by reference to the following description of embodiments of the invention taken in conjunction with the accompanying drawings, wherein:

FIG. 1 is side elevation of a baler;

FIG. 2 is a perspective view of a knotter assembly of the baler of FIG. 1;

FIG. 3 perspective view of a billhook assembly of the knotter assembly of FIG. 2 in accordance with principles of the present invention; and

FIG. 4 is a partially exploded perspective view of the billhook assembly FIG. 2.

Corresponding reference characters indicate corresponding parts throughout the views of the drawings.

### DETAILED DESCRIPTION OF EXEMPLARY EMBODIMENTS

The invention will now be described in the following detailed description with reference to the drawings, wherein preferred embodiments are described in detail to enable practice of the invention. Although the invention is described with reference to these specific preferred embodiments, it will be understood that the invention is not limited to these preferred embodiments. But to the contrary, the invention includes numerous alternatives, modifications and equivalents as will become apparent from consideration of the following detailed description.

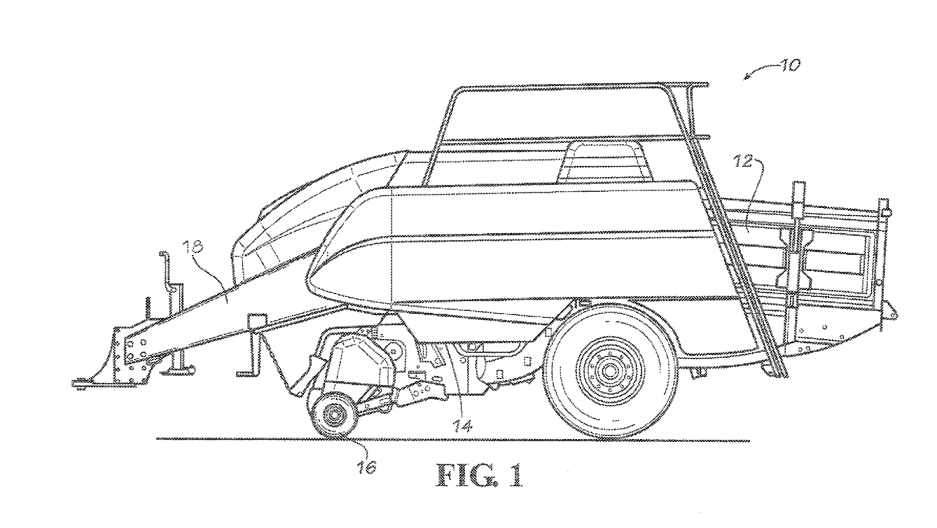

Turning to the figures, wherein like reference numerals represent like elements throughout the several views, FIG. 1 shows a baler 10 with a fore-and-aft extending baling chamber 12 mounted on a baler frame 14 within which bales of crop material are prepared. Crop material is collected with a pickup 16 below and slightly ahead of baling chamber 12 and then loaded up into the bottom of the chamber 12. Baler 10 may be hitched to a towing vehicle (not shown) by a tongue 18, and power for operating the various mechanisms of the baler may be supplied by the towing vehicle, such as the vehicle's power takeoff shaft.

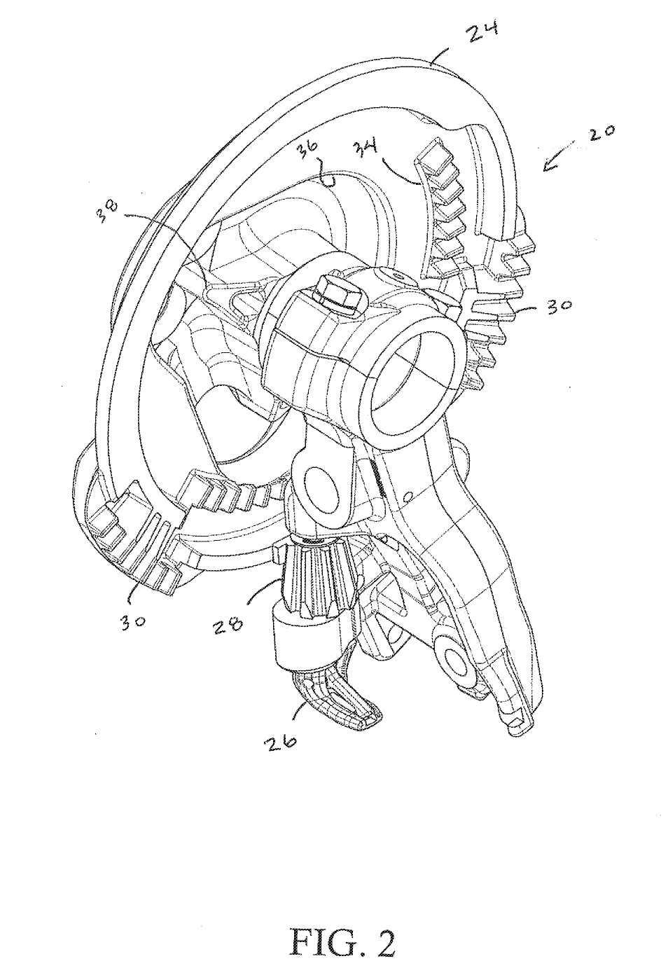

Turning now to FIG. 2, a knotter assembly 20, which is mountable to the frame 14 of the baler 10, is configured to take strands of twine, broadly binding material, looped around a finished bale and bind the strands with two knots. While twine is used in the exemplary embodiment, the term binding material is intended to mean not only twine made from natural or synthetic fibers, but may also include metallic wire or other strapping material. The knotter assembly 20 comprises a generally circular knotter disc 24 that is secured to a drive shaft (not shown) for rotation with the latter. The knotter assembly 20 includes a rotary billhook 26, supported by the frame 14 for rotation. As is known in the art, a twine disc (not shown) holds twine strands in position for engagement by the billhook 26 during rotation of the latter while a swing arm (not shown) pivots relative the frame 14 to during the process of tying a knot.

In order to transmit driving power to the billhook 26, the knotter disc 24 is provided with a pinion 28 which is disposed for meshing engagement with a pair of circumferentially spaced gear stretches 30 on the knotter disc 24. Similarly, driving power is transmitted to the twine disc through a gear drive (not shown) in position for sequential meshing engagement with a pair of circumferentially spaced gear sections 34 on the knotter disc 24. Power to swing the swing arm is obtained through a cam follower (not shown) at the upper end of the arm which is disposed within a cam track 36 on the knotter disc 24. A pair of circumferentially spaced cam shoulders 38 in the track 36 is positioned to sequentially engage the follower to operate the latter. When the bale has reached its desired length and it is time to complete the loop around the bale and make the second knot in the loop the twine is carried toward the knotter assembly 20 where the knot is formed using conventional means.

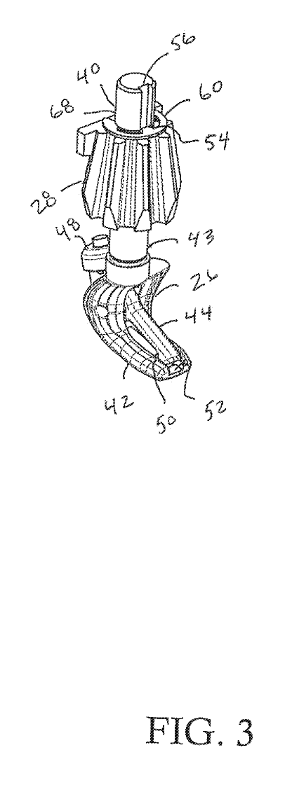

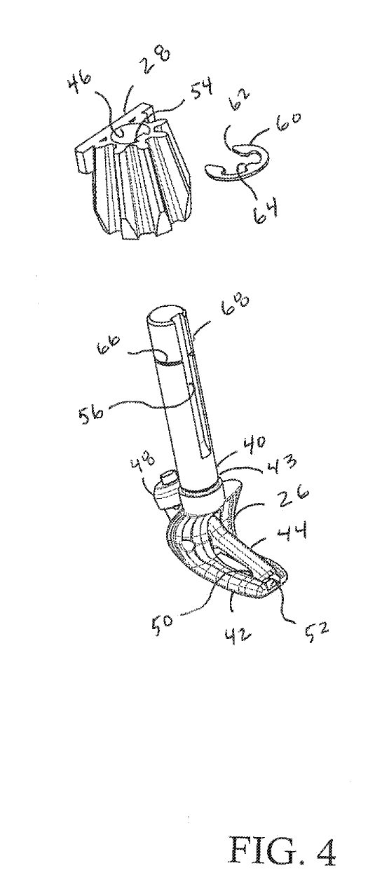

The billhook 26 is illustrated in detail in FIGS. 3 and 4 and comprises a billhook shaft 40 with a lower finger 42 at a proximal end 43 of the shaft 40, and an upper finger 44 connected around a pivot point with the lower finger 42. The billhook shaft 40 engages a circular opining 46 in the pinion 28. When the billhook shaft 40 rotates around its axis A, a cam follower 48, which is connected to the upper finger 44, engages an element having a cam shoulder (not shown). When rotating, the cam follower 48 will push the upper finger 44 away from the lower finger 42, thus enabling the twine to enter in between the two fingers 42, 44 while the billhook 26 is rotated. The upper finger 44 is provided at a free end thereof with a downwardly protruding detent 50, and the lower finger 42 is provided with an end recess 52 for receiving the detent 50 to ensure proper capture of the twine during the knot forming process.

As is known in the art, rotational movement of the billhook 26 is driven by the knotter disc 24 through engagement of the gear stretches 30 with the pinion 28. The billhook 26 engages the pinion 28 such that the two rotate together and forces are transmitted from the pinion 28 to the billhook 26. As best seen in FIG. 4, the pinion 28 has a key 54 that extends into the pinion opening 30 that is configured to engage with a notch 56 formed along a portion of the billhook shaft 40. Connecting the pinion 28 with the billhook 26 using the key 54 allows the pinion 28 to transmit more power to the billhook 26 with less stress on the billhook shaft 40. While the illustrated embodiment shows the key 54 on the pinion 28 and the notch 56 in the billhook shaft 40, one skilled in the aft will understand that the key could be disposed on the billhook shaft 40 and the notch 56 formed in the pinion 28 without departing from the scope of the invention. Additionally, other means, such as a pinned connection, may be used to engage the pinion with the billhook shaft 40.

According to the invention, a retaining clip 60 is clipped on the billhook shaft 40 and is used to set the location of the pinion 28 with respect to the billhook 26. The clip 60 also holds the billhook 26 in place in the event of failure of the key 54. The clip 60 In the illustrated embodiment, the retaining clip 60 is generally C-shaped with a mouth 62 configured to receive the billhook shaft 40 and teeth 64 that engage a groove 66 around at least a portion of the circumference of the billhook shaft 40. The retaining clip 60 is positioned closer to a distal end 68 of the billhook shaft 40 above the pinion 28 to prevent the billhook 26 from separating from the pinion 28.

The foregoing has broadly outlined some of the more pertinent aspects and features of the present invention. These should be construed to be merely illustrative of some of the more prominent features and applications of the invention. Other beneficial results can be obtained by applying the disclosed information in a different manner or by modifying the disclosed embodiments. Accordingly, other aspects and a more comprehensive understanding of the invention may be obtained by referring to the detailed description of the exemplary embodiments taken in conjunction with the accompanying drawings.

1. A knotter assembly for use with a baler, the knotter assembly configured to form knots in strands of a binding material used to secure a formed bale, the knotter assembly comprising a generally circular knotter disc, a rotary billhook, and a pinion which is disposed for meshing engagement with a pair of circumferentially spaced gear stretches on the knotter disc such that rotational movement of the billhook is driven by the knotter disc through engagement of the gear stretches with the pinion, the billhook comprising a billhook shaft, wherein the billhook shaft is received in an opening of the pinion, and wherein a retaining clip engages the billhook shaft to set the location of the pinion with respect to the billhook.

2. The knotter assembly of claim 1 wherein the retaining clip is C-shaped with a mouth configured to receive the billhook shaft and teeth that engage a groove around at least a portion of the circumference of the billhook shaft.
